(19) United States
(12) Patent Application Publication
(10) Pub. No.: US 2016/0364556 A1
(43) Pub. Date: Dec. 15, 2016

(54) Computer System and Method for User Authentication

(71) Applicant: Llewellyn Daniel, Gray, GA (US)

(72) Inventor: Llewellyn Daniel, Gray, GA (US)

(21) Appl. No.: 15/131,170

(22) Filed: Apr. 18, 2016

Related U.S. Application Data
(60) Provisional application No. 62/175,498, filed on Jun. 15, 2015.

(51) Int. Cl. G06F 21/31; G06F 21/88; G06F 21/46

(52) U.S. Cl. CPC G06F 21/31; G06F 21/46; G06F 21/88; G06F 2221/031

(57) ABSTRACT

A computer system and method for user authentication and theft prevention. The computer system includes a speaker, a display, a processor, a non-transitory computer readable medium operatively connected to the processor, and a logic stored in the non-transitory computer readable medium that, when executed by the processor, causes the computer system to perform a method. The method includes the step of accepting a first password input from a user. If a predetermined number of incorrect inputs occur, the computer system emits an alarm through the speaker and displays contact information of the owner on the display. The user must then input a second password distinct from the first password in order to stop the alarm. After the alarm stops, the user must input a third password, which may be different than the first password, in order to access the computer system.

### CROSS REFERENCE TO RELATED APPLICATIONS

This application claims the benefit of U.S. Provisional Application No. 62/175,498 filed on Jun. 15, 2015. The above identified patent application is herein incorporated by reference in its entirety to provide continuity of disclosure.

### FIELD OF THE INVENTION

The present invention relates to computer systems and computer implemented methods. More specifically, the present invention provides a computer system and method for user authentication and theft prevention.

### BACKGROUND OF THE INVENTION

Many individuals utilize computer systems for various purposes such as work and leisure. Many of these same individuals utilize portable computer systems such as laptops and smartphones, which allow users to utilize a computer system remotely from any location. One drawback to portable computer systems is that they are often prone to theft. Computer systems are often expensive and as such are common theft targets. Further, due to the prevalence of portable computer systems, thieves can simply act as though the stolen computer system belongs to them and complete the theft without arousing the suspicions of the general public. There is therefore a need for a computer system and method for authenticating users and preventing theft.

There exists computer systems and methods for deterring theft in the prior art. For example, one method of deterring theft is for the computer system to require the input of a password before providing a user access thereto. Typically, the computer system locks down after a number of incorrect password attempts. It can be difficult to determine the owner of a computer system that has been locked down due to repeated unsuccessful password inputs. If a computer system is recovered by a person not having the password to access the system, the person will be unable to determine the owner of the system and thus unable to return the system to them. As such, individuals who have their computer systems stolen are unlikely to recover the stolen goods. Further, only requiring a password input is insufficient because a thief may simply relocate the computer system and attempt to access it elsewhere. Therefore, there is a need for a computer system and method for authenticating users and deterring theft that alerts the general public via an audible signal when a number of incorrect password attempts are received.

In light of the deficiencies of prior art system and methods for user authentication and theft prevention, it is submitted that the present invention diverges substantially from the prior art. As such, there is a need in the art for an improvement to computer systems and methods for user authentication and theft prevention. In this regard, the present invention substantially fulfills these needs.

### SUMMARY OF THE INVENTION

In view of the foregoing disadvantages inherent in the known types of computer systems and methods for user authentication now present in the prior art, the present invention provides a computer system and method for user authentication wherein the same can be utilized for providing convenience for the user when authenticating the user of a computer system in order to prevent theft. The present system comprises a computer system having a display, a speaker, a processor, a non-transitory computer readable medium operatively connected to the processor, and a logic stored in the non-transitory computer readable medium that, when executed by the processor, causes the computer system to perform a method. The method comprising the steps of receiving a first input from a user. If the first input matches a first password stored in the non-transitory computer readable medium, then the user is provided access to the computer system. If the first input does not match the first stored password, then the computer system emits an alarm from the speaker and displays contact information of the owner on the display. The computer system then receives a second input from the user. If the second input matches a second password stored in the non-transitory computer readable medium, then the speaker stops emitting the alarm. Then, a third password, which may be different from the first password, is required before access is allowed.

One object of the present invention is to provide a computer system and method for user authentication having all of the advantages of the prior art and none of the disadvantages.

Another object of the present invention is to provide a computer system and method for user authentication that deters theft.

A further object of the present invention is to provide a computer system and method for user authentication that displays contact information of the owner.

Yet another object of the present invention is to provide a computer system and method for user authentication that requires input of a third password in order to provide additional security.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of a computer system according to the present invention.

FIG. 2 shows a flowchart detailing the steps of a computer-implemented method according to the present invention.

### DETAILED DESCRIPTION OF THE INVENTION

Reference is made herein to the attached drawings. Like reference numerals are used throughout the drawings to depict like or similar elements of the computer system and accompanying method. For the purposes of presenting a brief and clear description of the present invention, the preferred embodiment will be discussed as used for computer system user authentication and theft prevention. The figures are intended for representative purposes only and should not be considered to be limiting in any respect.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

The system and method of the present invention provides user authentication which helps to prevent theft of a computer system or other electronic device. The system requires an input of a first password in order to provide a user access thereto. If the first password input is incorrect, the system allows for a pre-determined number of retries to input a correct first password. After a specific number of incorrect inputs, the system emits an alarm from a speaker and displays identify information regarding the owner of the computer system. The system then requires the input of a second password to stop the alarm, and the alarm will continue to sound until the correct second password is received from the user. Once the second password has been received and the alarm is stopped, the system requires the input of the first password in order to provide access thereto. In an alternative embodiment, the system requires the input of a third password before allowing access thereto, which provides additional security.

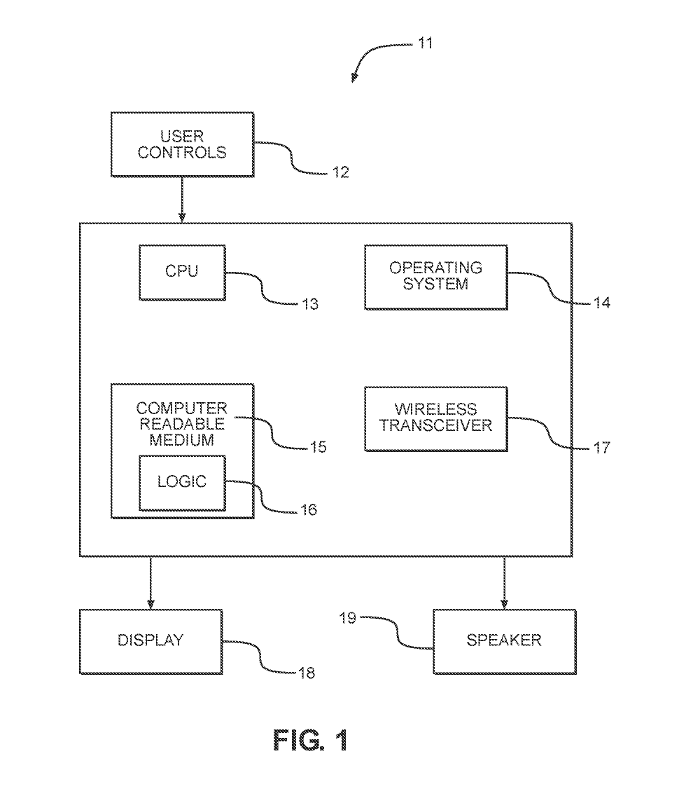

Referring now to FIG. 1, there is shown a diagram of a computer system according to the present invention. The computer system 11 generally comprises a CPU 13, a computer readable medium 15, and a logic 16 stored in the computer readable medium. The computer system 11 is not limited to these components and can further include additional components common to computer systems such as an operating system 14 or a wireless transceiver 17. The computer system 11 further comprises user controls 12. The user controls 12 allow a user to input information into the computer system 11. The user controls 12 can be buttons, touchscreens, keyboards, or any suitable means for inputting information to the computer system 11.

The computer system 11 further comprises a speaker 19. The speaker 19 is configured to emit an alarm sound, wherein the alarm sound is stored in the computer readable medium 15. The alarm sound can be any sound but is preferably one capable of alerting the general public in the vicinity of the computer system 11. The computer system 11 additionally comprises a display 18. The display 18 is configured to display various information stored on the computer readable medium 15. For example, the display 18 displays contact information relating to the owner of the computer system 11, such as the owner's name and address. In this way, the computer system 11 may be returned to the rightful owner if stolen. It is contemplated that the computer system 11 may be a smartphone, laptop, tablet, or other portable device that is prone to theft.

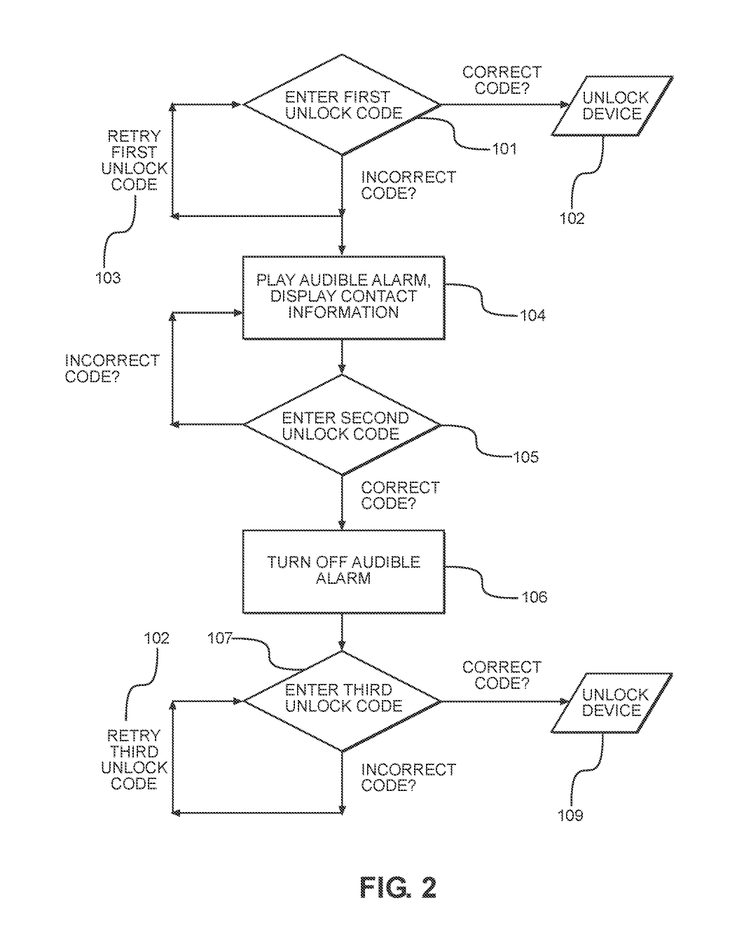

Referring now to FIG. 2, there is shown a flowchart detailing the steps of a computer-implemented method according to the present invention. Each of the steps of the flowchart are initiated by the logic stored in the non-transitory computer readable medium that, when executed by the processor, causes the computer system to perform the following method. The method comprises a first step of entering a first unlock code 101. The first unlock code comprises a password or passcode and may further comprise any combination of letters, numbers, or symbols according to user preference. If the user input matches the first unlock code, then the logic causes the device to unlock 102, providing the user with access to the computer system.

If an incorrect unlock code 101 is received, the user is not permitted to access the computer system. In order to access the computer system, the user must retry 103 the first unlock code until the computer system receives the correct first unlock code 101. The user has a predetermined number of attempts to enter the first unlock code 101. If the user exceeds the predetermined number of attempts, then the logic causes the speaker to emit an alarm via the speaker and display information via the display 104. The information displayed comprises the contact information of the owner of the computer system. The information may include names, addresses, and other identifying information. This allows the computer system to be returned to the proper owner in the event that the computer system is stolen.

In order to turn off the alarm and regain access to the computer system, the system must receive from the user a second unlock code 105 that is distinct from the first unlock code. The user has an unlimited number of attempts to enter the correct second unlock code, and the alarm will continue to sound until the correct second unlock code is received 105. Once the corrected second unlock code is received 105, the alarm is turned off 106.

Once the correct second unlock code is entered 105 and the alarm is turned off 106, the system is configured to receive a third unlock code 107. In one embodiment of the invention, the third unlock code is the same as the first unlock code. In an alternate embodiment, the third unlock code is distinct from the first unlock code, which provides an additional layer of security. The user has a predetermined number of attempts to retry 102 entering the third unlock code. After receiving the correct third unlock code, the device unlocks 109. It is contemplated that unlimited attempts may be utilized for the third code, because the user has to have first entered a correct second unlock code in order to stop the alarm. However, the contact information of the owner of the computer system preferably remains displayed on the display until the user is provided access to the device via the correct unlock code inputs in order to provide additional security.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A computer system comprising:
a speaker;
a display;
a processor;
a non-transitory computer readable medium operatively connected to the processor;
a logic stored in the non-transitory computer readable medium that, when executed by the processor, causes the computer system to perform a method, the method comprising the steps of:
receiving a first input from a user;
providing the user access to the computer system if the first input matches a first password stored in the non-transitory computer readable medium;
emitting an alarm from the speaker and displaying information on the display if the first input does not match the first stored password, then;
receiving a second input from the user;
stopping the speaker from emitting the alarm if the second input matches a second password stored in the non-transitory computer readable medium, then.

2) The computer system of claim 1, wherein the performed method further comprises:
receiving a third input from the user;
providing the user access to the computer system if the third input matches the first password.

3) The computer system of claim 1, wherein the performed method further comprises:
receiving a third input from the user;
providing access to the computer system if the third input matches a third password stored in the non-transitory computer readable medium.

4) The computer system of claim 2, wherein the performed method further comprises:
emitting the alarm from the speaker and displaying information on the display if the third input does not match the first password.

5) The computer system of claim 3, wherein the performed method further comprises:
emitting the alarm from the speaker and displaying information on the display if the third input does not match the third password.

6) The computer system of claim 1, wherein the information displayed on the display comprises identifying information of an owner of the computer system.

7) The computer system of claim 1, wherein the computer system is one of a smartphone, tablet, or laptop.

8) A non-transitory computer readable medium that, when executed by a processor of a computer system having a speaker and a display, causes the computer system to perform a method, the method comprising the steps of:
receiving a first input from a user;
providing access to the computer system if the first input matches a first password stored in the non-transitory computer readable medium;
emitting an alarm from the speaker and displaying information on the display if the first input does not match the first stored password;
receiving a second input from the user;
stopping the speaker from emitting the alarm if the second input matches a second password stored in the non-transitory computer readable medium.

9) The non-transitory computer readable medium of claim 7, wherein the performed method further comprises:
receiving a third input;
providing the user access to the computer system if the third input matches the first password.

10) The non-transitory computer readable medium of claim 7, wherein the performed method further comprises:
receiving a third input from the user;
providing access to the computer system if the third input matches a third password stored in the non-transitory computer readable medium.

11) A computer-implemented method comprising the steps of:
receiving a first input from a user;
providing the user access to the computer system if the first input matches a first password stored in the non-transitory computer readable medium;
emitting an alarm from the speaker and displaying information on the display if the first input does not match the first stored password, then;
receiving a second input from the user;
stopping the speaker from emitting the alarm if the second input matches a second password stored in the non-transitory computer readable medium, then.

12) The computer-implemented method of claim 11 further comprising:
receiving a third input from the user;
providing the user access to the computer system if the third input matches the first password.

13) The computer-implemented method of claim 11 further comprising:
receiving a third input from the user;
providing the user access to the computer system if the third input matches a third password stored in the non-transitory computer readable medium.
